(19) United States
(12) Patent Application Publication
(10) Pub. No.: US 2015/0268802 A1
(43) Pub. Date: Sep. 24, 2015

(54) MENU CONTROL METHOD AND MENU CONTROL DEVICE INCLUDING TOUCH INPUT DEVICE PERFORMING THE SAME

(71) Applicant: HiDeep Inc., Gyeonggi-do (KR)

(72) Inventors: Seyeob Kim, Gyeonggi-do (KR); Sangsic Yoon, Gyeonggi-do (KR); Sunyoung Kwon, Gyeonggi-do (KR); Hojun Moon, Gyeonggi-do (KR); Taehoon Kim, Gyeonggi-do (KR); Bonkee Kim, Gyeonggi-do (KR); Insung Lee, Gyeonggi-do (KR)

(21) Appl. No.: 14/618,750

(22) Filed: Feb. 10, 2015

(30) Foreign Application Priority Data
Mar. 24, 2014 (KR) 1020140034169
Mar. 26, 2014 (KR) 1020140035262
May 9, 2014 (KR) 1020140055732
Aug. 1, 2014 (KR) 1020140098917
Sep. 19, 2014 (KR) 1020140124920
Oct. 24, 2014 (KR) 1020140145022
Dec. 22, 2014 (KR) 1020140186352

(51) Int. Cl. G06F 3/0482; G06F 3/0488; G06F 3/0481; G06F 3/0484; G06F 3/041; G06F 3/044

(52) U.S. Cl. CPC G06F 3/0482; G06F 3/0416; G06F 3/044; G06F 3/04817; G06F 3/04847; G06F 3/04842; G06F 3/04883

(57) ABSTRACT

A menu control method may be provided that includes: determining whether or not a touch input to a touch input device by an object satisfies at least any one of a condition that the object touches the touch input device for a time period longer than a predetermined time period, a condition that the object touches with a pressure magnitude greater than a predetermined pressure magnitude, a condition that the object touches with an area greater than a predetermined area, a condition that the object touches in a predetermined pattern, a condition that the object drags from a predetermined position, and a condition that the object touches to a predetermined rhythm; displaying the menu on the touch input device when the touch input satisfies the predetermined condition; and controlling operation of the touch input device according to manipulation to the menu by the object.

### CROSS REFERENCE TO RELATED APPLICATIONS

Priority is claimed under 35 U.S.C. §119 to the following foreign patent applications:
Korean Patent Application No.: 10-2014-0035262, filed Mar. 26, 2014;
Korean Patent Application No.: 10-2014-0034169, filed Mar. 24, 2014;
Korean Patent Application No.: 10-2014-0055732, filed May 9, 2014;
Korean Patent Application No.: 10-2014-0098917, filed Aug. 1, 2014;
Korean Patent Application No.: 10-2014-0124920, filed Sep. 19, 2014;
Korean Patent Application No.: 10-2014-0145022, filed Oct. 24, 2014; and
Korean Patent Application No.: 10-2014-0186352, filed Dec. 22, 2014.

The disclosures of the aforementioned priority applications are incorporated herein by reference in their entireties.

### FIELD OF THE INVENTION

The present invention relates to a menu control method and a menu control device including a touch input device performing the same.

### BACKGROUND OF THE INVENTION

A touch input device is used in a portable electronic device like a personal digital assistant (PDA), a tabletop, and a mobile device. The touch input device can be operated by a pointing device (or stylus) or a finger.

However, the input device of the device including such a touch input device has generally a fixed shape and size. Therefore, it is very difficult or impossible to customize the input device of the device for convenience of users. Moreover, there is a tendency to make the touch input device of the device wider and larger, a user has a difficulty in operating the device throughout the entire touch input device by one hand. Also, since icons are distributed on a plurality of pages in the device including the touch input device, many operations are required to perform an action assigned to an icon to be used.

Therefore, there is a requirement for improvement of user's convenience by providing an intuitive interfacing technology of providing natural interface and of enhancing the interaction between human being and computers.

### SUMMARY OF THE INVENTION

One embodiment is a menu control method including: determining whether or not a touch input to a touch input device by an object satisfies at least any one of a condition that the object touches the touch input device for a time period longer than a predetermined time period, a condition that the object touches with a pressure magnitude greater than a predetermined pressure magnitude, a condition that the object touches with an area greater than a predetermined area, a condition that the object touches in a predetermined pattern, a condition that the object drags from a predetermined position, and a condition that the object touches to a predetermined rhythm; displaying the menu on the touch input device when the touch input satisfies the predetermined condition; and controlling operation of the touch input device according to manipulation to the menu by the object.

Another embodiment is a menu control device including a touch input device, a processor and a controller. The processor measures a capacitance change amount according to a touch of an object on the touch input device and transmits at least one of the measured capacitance change amount and a touch position and a magnitude of a touch pressure calculated from the measured capacitance change amount to the controller. Based on at least one of the capacitance change amount, the touch position, the magnitude of the touch pressure which have been transmitted from the processor, the controller determines whether or not the touch of the object on the touch input device satisfies at least any one of a condition that the object touches the touch input device for a time period longer than a predetermined time period, a condition that the object touches with a pressure magnitude greater than a predetermined pressure magnitude, a condition that the object touches with an area greater than a predetermined area, a condition that the object touches in a predetermined pattern, a condition that the object drags from a predetermined position, and a condition that the object touches to a predetermined rhythm; displays the menu on the touch input device when the touch input satisfies the predetermined condition; and controls operation of the touch input device according to manipulation to the menu by the object.

### BRIEF DESCRIPTION OF THE DRAWINGS

FIG. 1 is a structure view of a menu control device according to an embodiment of the present invention;

FIGS. 2a and 2b are views for describing the capacitance change amount due to pressure;

FIGS. 3a and 3b are views for describing the capacitance change amount due to the area;

FIGS. 4a and 4b are views for describing the touch time period;

FIG. 5 is a flowchart for describing a menu control method according to the embodiment of the present invention;

FIG. 6 shows an example of the menu control method according to the embodiment of the present invention;

FIGS. 7a to 7c show various menus according to a first embodiment;

FIGS. 8a and 8b show a menu according to a second embodiment;

FIG. 9 shows a menu exit method in accordance with the embodiment;

FIG. 10 shows a structure of a touch input device according to the first embodiment;

FIGS. 11a to 11d show a structure of a touch position sensing module of the touch input device according to the first embodiment;

FIGS. 12a to 12f show a structure of a touch pressure sensing module of the touch input device according to the first embodiment;

FIG. 13 shows a structure of the touch input device according to the second embodiment;

FIGS. 14a to 14k show a structure of a touch position-pressure sensing module of the touch input device according to the second embodiment;

FIG. 15 shows a structure of the touch input device according to a third embodiment;

FIGS. 16a to 16b show a structure of a touch pressure sensing module of the touch input device according to the third embodiment;

FIG. 17a shows a structure of the touch input device according to a fourth embodiment;

FIGS. 17b and 17c are structure views of touch pressure sensing and touch position sensing of the touch input device according to the fourth embodiment; and

FIGS. 18a to 18d are structure views showing the shape of an electrode formed in the touch sensing module according to the embodiment.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

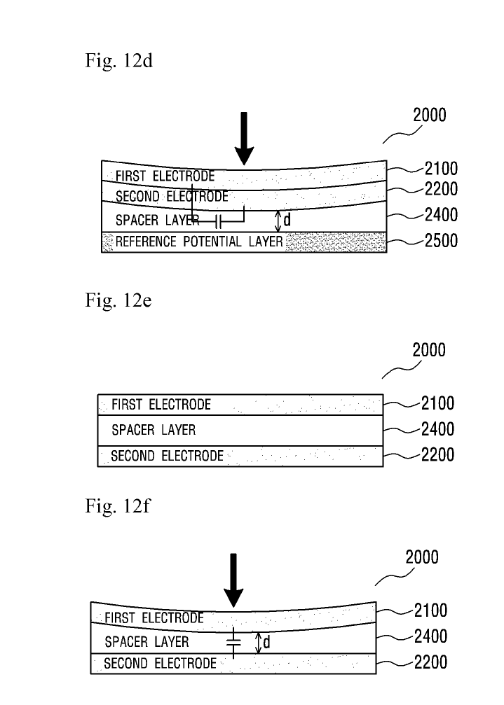

Hereafter, a menu control method and a menu control device 100 including a touch input device performing the same in accordance with an embodiment of the present invention will be described with reference to the accompanying drawings. Prior to the description of the functions and features of the menu control device 100 according to the embodiment of the present invention, a touch input device 130 will be described in detail with reference to FIGS. 10 to 18.

FIG. 10 shows a structure of a touch input device 130 according to the first embodiment.

As shown in FIG. 10, the touch input device 130 may include a touch position sensing module 1000, a touch pressure sensing module 2000 disposed under the touch position sensing module 1000, a display module 3000 disposed under the touch pressure sensing module 2000, and a substrate 4000 disposed under the display module 3000. For example, the touch position sensing module 1000 and the touch pressure sensing module 2000 may be a transparent panel including a touch-sensitive surface. Hereafter, the modules 1000, 2000, 3000 and 5000 for sensing the touch position and/or touch pressure may be collectively designated as a touch sensing module.

The display module 3000 is able to display the screen to allow a user to visually check contents. Here, the display module 3000 may display by means of a display driver. The display driver (not shown) is software allowing an operating system to manage or control a display adaptor and is a kind of a device driver.

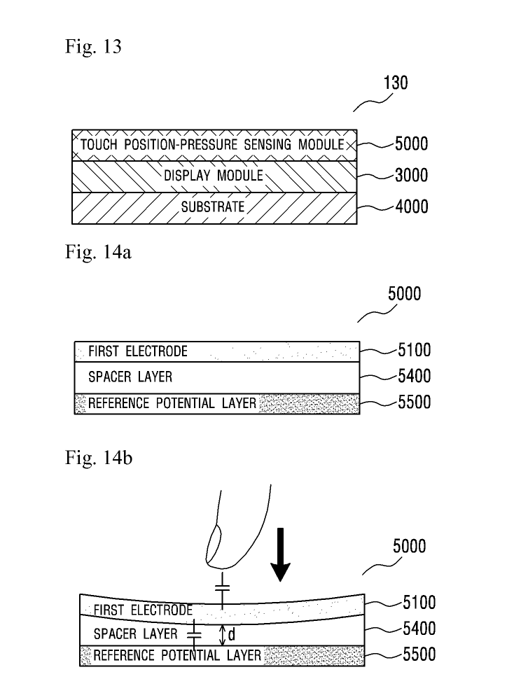

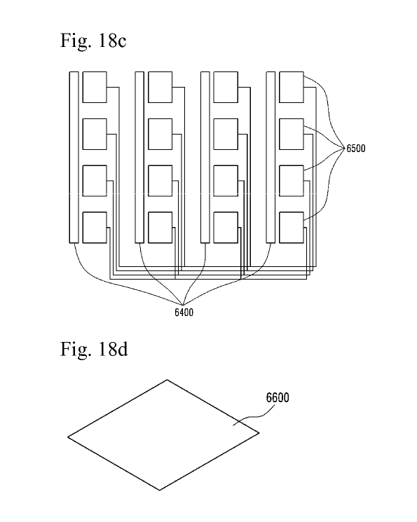

FIGS. 11a to 11d show a structure of the touch position sensing module according to the first embodiment. FIGS. 18a to 18c are structure views showing the shape of an electrode formed in the touch position sensing module according to the embodiment.

As shown in FIG. 11a, the touch position sensing module 1000 according to the embodiment may include a first electrode 1100 formed in one layer. Here, the first electrode 1100 may be, as shown in FIG. 18a, comprised of a plurality of electrodes 6100, and then a driving signal may be input to each electrode 6100 and a sensing signal including information on self-capacitance may be output from each electrode. When an object like a user's finger approaches the first electrode 1100, the finger functions as a ground and the self-capacitance of first electrode 1100 is changed. Therefore, the menu control device 100 is able to detect the touch position by measuring the self-capacitance of the first electrode 1100, which is changed as the object like the user's finger approaches the touch input device 130.

As shown in FIG. 11b, the touch position sensing module 1000 according to the embodiment may include the first electrode 1100 and a second electrode 1200, which are formed on different layers.

Here, the first and the second electrodes 1100 and 1200 are, as shown in FIG. 18b, comprised of a plurality of first electrodes 6200 and a plurality of second electrodes 6300 respectively. The plurality of first electrodes 6200 and the plurality of second electrodes 6300 may be arranged to cross each other. A driving signal may be input to any one of the first electrode 6200 and the second electrode 6300, and a sensing signal including information on mutual capacitance may be output from the other. As shown in FIG. 11b, when the object like the user's finger approaches the first electrode 1100 and the second electrode 1200, the finger functions as a ground, so that the mutual capacitance between the first electrode 1100 and the second electrode 1200 is changed. In this case, the menu control device 100 measures the mutual capacitance between the first electrode 1100 and the second electrode 1200, which is changed with the approach of the object like the user's finger to the touch input device 130, and then detects the touch position. Also, the driving signal may be input to the first electrode 6200 and the second electrode 6300, and a sensing signal including information on the self-capacitance may be output from the first and second electrodes 6200 and 6300 respectively. As shown in FIG. 11c, when the object like the user's finger approaches the first electrode 1100 and the second electrode 1200, the finger functions as a ground, so that the self-capacitance of each of the first and second electrodes 1100 and 1200 is changed. In this case, the menu control device 100 measures the self-capacitances of the first electrode 1100 and the second electrode 1200, which is changed with the approach of the object like the user's finger to the touch input device 130, and then detects the touch position.

As shown in FIG. 11d, the touch position sensing module 1000 according to the embodiment may include the first electrode 1100 formed in one layer and the second electrode 1200 formed in the same layer as the layer in which the first electrode 1100 has been formed.

Here, the first and the second electrodes 1100 and 1200 are, as shown in FIG. 18c, comprised of a plurality of first electrodes 6400 and a plurality of second electrodes 6500 respectively. The plurality of first electrodes 6400 and the plurality of second electrodes 6500 may be arranged without crossing each other and may be arranged such that the plurality of second electrodes 6500 are connected to each other in a direction crossing the extension direction of the each first electrodes 6400. A principle of detecting the touch position by using the first electrode 6400 or the second electrode 6500 shown in FIG. 11d is the same as that of the foregoing referring to FIG. 11c, and thus a description of the principle will be omitted.

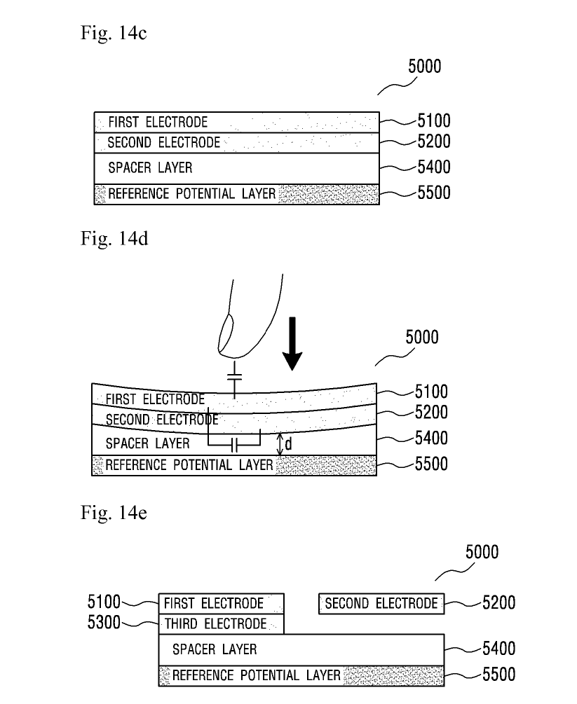

FIGS. 12a to 12f show a structure of the touch pressure sensing module according to the first embodiment. FIGS. 18a to 18d are structure views showing the shape of the electrode formed in the touch pressure sensing module according to the embodiment.

As shown in FIGS. 12a to 12f, the touch pressure sensing module 2000 according to the first embodiment may include a spacer layer 2400. The spacer layer 2400 may be implemented by an air gap. The spacer may be comprised of an impact absorbing material according to the embodiment and may be also filled with a dielectric material according to the embodiment.

As shown in FIGS. 12a to 12d, the touch pressure sensing module 2000 according to the first embodiment may include a reference potential layer 2500. The reference potential layer 2500 may have any potential. For example, the reference potential layer may be a ground layer having a ground potential. Here, the reference potential layer may include a layer which is parallel with a two-dimensional plane in which a below-described first electrode 2100 for sensing the touch pressure has been formed or a two-dimensional plane in which a below-described second electrode 2200 for sensing the touch pressure has been formed. Although it has been described in FIGS. 12a to 12d that the touch pressure sensing module 2000 includes the reference potential layer 2500, there is no limit to this. The touch pressure sensing module 2000 does not include the reference potential layer 2500, and the display module 3000 or the substrate 4000 which is disposed under the touch pressure sensing module 2000 may function as the reference potential layer.

As shown in FIG. 12a, the touch pressure sensing module 2000 according to the embodiment may include the first electrode 2100 formed in one layer, the spacer layer 2400 formed under the layer in which the first electrode 2100 has been formed, and the reference potential layer 2500 formed under the spacer layer 2400.

Here, the first electrode 2100 is, as shown in FIG. 18a, comprised of the plurality of electrodes 6100. Then, the driving signal may be input to each of the electrodes 6100 and the sensing signal including information on the self-capacitance may be output from the each electrode. When a pressure is applied to the touch input device 130 by the object like the user's finger or stylus, the first electrode 2100 is, as shown in FIG. 12b, curved at least at the touch position, so that a distance “d” between the first electrode 2100 and the reference potential layer 2500 is changed, and thus, the self-capacitance of the first electrode 2100 is changed. Accordingly, the menu control device 100 is able to detect the touch pressure by measuring the self-capacitance of the first electrode 2100, which is changed by the pressure that the object like the user's finger or stylus applies to the touch input device 130. As such, since the first electrode 2100 is comprised of the plurality of electrodes 6100, the menu control device 100 is able to detect the pressure of each of multiple touches which have been simultaneously input to the touch input device 130. Also, when there is no requirement for detecting the pressure of each of multiple touches, it is only required to detect overall pressure applied to the touch input device 130 irrespective of the touch position. Therefore, the first electrode 2100 of the touch pressure sensing module 2000 may be, as shown in FIG. 18d, comprised of one electrode 6600.

As shown in FIG. 12c, the touch pressure sensing module 2000 according to the embodiment may include the first electrode 2100, the second electrode 2200 formed under the layer in which the first electrode 2100 has been formed, the spacer layer 2400 formed under the layer in which the second electrode 2200 has been formed, and the reference potential layer 2500 formed under the spacer layer 2400.

Here, the first electrode 2100 and the second electrode 2200 may be configured and arranged as shown in FIG. 18b. A driving signal is input to any one of the first electrode 6200 and the second electrode 6300, and a sensing signal including information on the mutual capacitance may be output from the other. When a pressure is applied to the touch input device 130, the first electrode 2100 and the second electrode 2200 are, as shown in FIG. 12d, curved at least at the touch position, so that a distance “d” between the reference potential layer 2500 and both the first electrode 2100 and the second electrode 2200 is changed, and thus, the mutual capacitance between the first electrode 2100 and the second electrode 2200 is changed. Accordingly, the menu control device 100 is able to detect the touch pressure by measuring the mutual capacitance between the first electrode 2100 and the second electrode 2200, which is changed by the pressure that is applied to the touch input device 130. As such, since the first electrode 2100 and the second electrode 2200 are comprised of the plurality of first electrodes 6200 and the plurality of second electrodes 6300 respectively, the menu control device 100 is able to detect the pressure of each of multiple touches which have been simultaneously input to the touch input device 130. Also, when there is no requirement for detecting the pressure of each of multiple touches, at least one of the first electrode 2100 and the second electrode 2200 of the touch pressure sensing module 2000 may be, as shown in FIG. 18d, comprised of the one electrode 6600.

Here, even when the first electrode 2100 and the second electrode 2200 are formed in the same layer, the touch pressure can be also detected as described in FIG. 12c. The first electrode 2100 and the second electrode 2200 may be configured and arranged as shown in FIG. 18c, or may be comprised of the one electrode 6600 as shown in FIG. 18d.

As shown in FIG. 12e, the touch pressure sensing module 2000 according to the embodiment may include the first electrode 2100 formed in one layer, the spacer layer 2400 formed under the layer in which the first electrode 2100 has been formed, and the second electrode 2200 formed under the spacer layer 2400.

In FIG. 12e, the configuration and operation of the first electrode 2100 and the second electrode 2200 are the same as those of the foregoing referring to FIG. 12c, and thus, a description of the configuration and operation will be omitted. When a pressure is applied to the touch input device 130, the first electrode 2100 is, as shown in FIG. 12f, curved at least at the touch position, so that a distance “d” between the first electrode 2100 and the second electrode 2200 is changed, and thus, the mutual capacitance between the first electrode 2100 and the second electrode 2200 is changed. Accordingly, the menu control device 100 is able to detect the touch pressure by measuring the mutual capacitance between the first electrode 2100 and the second electrode 2200.

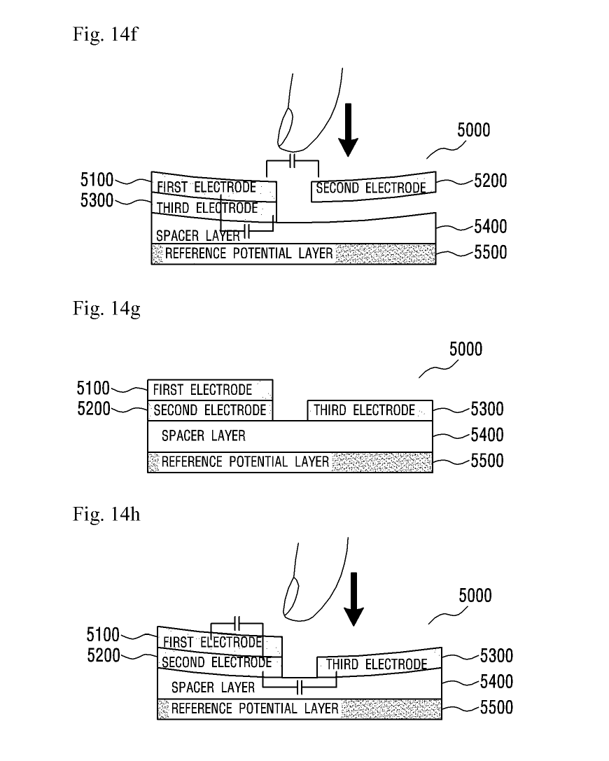

As shown in FIG. 13, a touch input device 130 according to a second embodiment may include a touch position-pressure sensing module 5000, a display module 3000 disposed under the touch position-pressure sensing module 5000, and a substrate 4000 disposed under the display module 3000.

Unlike the embodiment shown in FIG. 10, the touch position-pressure sensing module 5000 according to the embodiment shown in FIG. 13 includes at least one electrode for sensing the touch position, and at least one electrode for sensing the touch pressure. At least one of the electrodes is used to sense both the touch position and the touch pressure. As such, the electrode for sensing the touch position and the electrode for sensing the touch pressure are shared, so that it is possible to reduce the manufacturing cost of the touch position-pressure sensing module, to reduce the overall thickness of the touch input device 130 and to simplify the manufacturing process. In the sharing of the electrode for sensing the touch position and the electrode for sensing the touch pressure, when it is necessary to distinguish between the sensing signal including information on the touch position and the sensing signal including information on the touch pressure, it is possible to distinguish and sense the touch position and the touch pressure by differentiating a frequency of the driving signal for sensing the touch position from a frequency of the driving signal for sensing the touch pressure, or by differentiating a time interval for sensing the touch position from a time interval for sensing the touch pressure.

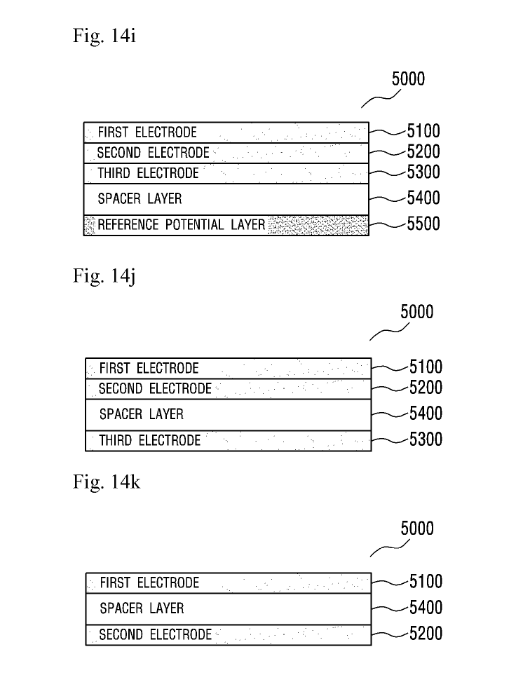

FIGS. 14a to 14k show a structure of the touch position-pressure sensing module according to the second embodiment. As shown in FIGS. 14a to 14k, the touch position-pressure sensing module 5000 according to the second embodiment may include a spacer layer 5400.

As shown in FIGS. 14a to 14i, the touch position-pressure sensing module 5000 according to the embodiment may include a reference potential layer 5500. The reference potential layer 5500 is the same as that of the foregoing referring to FIGS. 12a to 12d, and thus, a description of the reference potential layer 5500 will be omitted. The reference potential layer may include a layer which is parallel with a two-dimensional plane in which a below-described first electrode 5100 for sensing the touch pressure has been formed, a two-dimensional plane in which a below-described second electrode 5200 for sensing the touch pressure has been formed, or a two-dimensional plane in which a below-described third electrode 5300 for sensing the touch pressure has been formed.

As shown in FIG. 14a, the touch position-pressure sensing module 5000 according to the embodiment may include the first electrode 5100 formed in one layer, the spacer layer 5400 formed under the layer in which the first electrode 5100 has been formed, and the reference potential layer 5500 formed under the spacer layer 5400.

A description of the configuration of FIGS. 14a and 14b is similar to the description referring to FIGS. 12a and 12b. Hereafter, only the difference between them will be described. As shown in FIG. 14b, when the object like the user's finger approaches the first electrode 5100, the finger functions as a ground and the touch position can be detected by the change of the self-capacitance of the first electrode 5100. Also, when a pressure is applied to the touch input device 130 by the object, a distance “d” between the first electrode 5100 and the reference potential layer 5500 is changed, and thus, the touch pressure can be detected by the change of the self-capacitance of the first electrode 5100.

As shown in FIG. 14c, the touch position-pressure sensing module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the reference potential layer 5500 formed under the spacer layer 5400.

A description of the configuration of FIGS. 14c to 14f is similar to the description referring to FIGS. 12c and 12d. Hereafter, only the difference between them will be described. Here, the first electrode 5100 and the second electrode 5200 may be, as shown in FIG. 18a, comprised of the plurality of electrodes 6100 respectively. As shown in FIG. 14d, when the object like the user's finger approaches the first electrode 5100, the finger functions as a ground and the touch position can be detected by the change of the self-capacitance of the first electrode 5100. Also, when a pressure is applied to the touch input device 130 by the object, a distance “d” between the reference potential layer 5500 and both the first electrode 5100 and the second electrode 5200 is changed, and thus, the touch pressure can be detected by the change of the mutual capacitance between the first electrode 5100 and the second electrode 5200.

Also, according to the embodiment, each of the first and second electrodes 5100 and 5200 may be, as shown in FIG. 18b, comprised of the plurality of first electrodes 6200 and the plurality of second electrodes 6300. The plurality of first electrodes 6200 and the plurality of second electrodes 6300 may be arranged to cross each other. Here, the touch position can be detected by the change of the mutual capacitance between the first electrode 5100 and the second electrode 5200, and the touch pressure can be detected by the change of the self-capacitance of the second electrode 5200 according to the change of a distance “d” between the second electrode 5200 and the reference potential layer 5500. Also, according to the embodiment, the touch position can be detected by the change of the mutual capacitance between the first electrode 5100 and the second electrode 5200, and also, the touch pressure can be detected by the change of the mutual capacitance between the first electrode 5100 and the second electrode 5200 according to the change of the distance “d” between the reference potential layer 5500 and both the first electrode 5100 and the second electrode 5200.

Here, even when the first electrode 5100 and the second electrode 5200 are formed in the same layer, the touch position and touch pressure can be also detected as described with reference to FIGS. 14c and 14d. However, in FIGS. 14c and 14d, regarding the embodiment where the electrode should be configured as shown in FIG. 18b, when the first electrode 5100 and the second electrode 5200 are formed in the same layer, the first electrode 5100 and the second electrode 5200 may be configured as shown in FIG. 18c.

As shown in FIG. 14e, the touch position-pressure sensing module 5000 according to the embodiment may include the first electrode 5100 and the second electrode 5200 which have been in the same layer, the third electrode 5300 which has been formed in a layer under the layer in which the first electrode 5100 and the second electrode 5200 have been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 18c, and the first electrode 5100 and the third electrode 5300 may be configured and arranged as shown in FIG. 18b. As shown in FIG. 14f, when the object like the user's finger approaches the first electrode 5100 and the second electrode 5200, the mutual capacitance between the first electrode 5100 and the second electrode 5200 is changed, so that the touch position can be detected. When a pressure is applied to the touch input device 130 by the object, a distance “d” between the reference potential layer 5500 and both the first electrode 5100 and the third electrode 5300 is changed, and then the mutual capacitance between the first electrode 5100 and the third electrode 5300 is hereby changed, so that the touch pressure can be detected. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 14g, the touch position-pressure sensing module 5000 according to the embodiment may include the first electrode 5100 formed in one layer, the second electrode 5200 formed in a layer under the layer in which the first electrode 5100 has been formed, the third electrode 5300 formed in the same layer as the layer in which the second electrode 5200 has been formed, the spacer layer 5400 formed under the layer in which the second electrode 5200 and the third electrode 5300 have been formed, and the reference potential layer 5500 formed under the spacer layer 5400.

Here, the first electrode 5100 and the second electrode 5200 may be configured and arranged as shown in FIG. 18b, and the second electrode 5200 and the third electrode 5300 may be configured and arranged as shown in FIG. 18c. In FIG. 14h, the touch position can be detected by the change of the mutual capacitance between the first electrode 5100 and the second electrode 5200, and the touch pressure can be detected by the change of the mutual capacitance between the second electrode 5200 and the third electrode 5300. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 14i, the touch position-pressure sensing module 5000 according to the embodiment may include the first electrode 5100 formed in one layer, the second electrode 5200 formed in a layer under the layer in which the first electrode 5100 has been formed, the third electrode 5300 formed under the layer in which the second electrode 5200 has been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 18b, and the second electrode 5200 and the third electrode 5300 may be also configured and arranged as shown in FIG. 18b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch input device 130 by the object, a distance “d” between the reference potential layer 5500 and both the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 14j, the touch position-pressure sensing module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the third electrode 5300 formed under the spacer layer 5400.

Here, the first electrode 5100 and the second electrode 5200 may be configured and arranged as shown in FIG. 18b, and the third electrode 5300 may be configured as shown in FIG. 18a or the second electrode 5200 and the third electrode 5300 may be also configured and arranged as shown in FIG. 18b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch input device 130 by the object, a distance “d” between the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 14k, the touch position-pressure sensing module 5000 according to the embodiment may include the first electrode 5100 formed in one layer, the spacer layer 5400 formed under the layer in which the first electrode 5100 has been formed, and the second electrode 5200 formed under the spacer layer 5400.

Here, the first electrode 5100 and the second electrode 5200 may be configured and arranged as shown in FIG. 18b. Here, the touch position can be detected by the change of the mutual capacitance between the first electrode 5100 and the second electrode 5200. Also, when a pressure is applied to the touch input device 130 by the object, a distance “d” between the first electrode 5100 and the second electrode 5200 is changed, so that the touch pressure can be detected by the change of the mutual capacitance between the first electrode 5100 and the second electrode 5200. The first electrode 5100 and the second electrode 5200 may be configured and arranged as shown in FIG. 18a. Here, when the object like the user's finger approaches the first electrode 5100, the finger functions as a ground and the self-capacitance of the first electrode 5100 is changed, so that the touch position can be detected. Also, the touch pressure can be detected by the change of the mutual capacitance between the first electrode 5100 and the second electrode 5200.

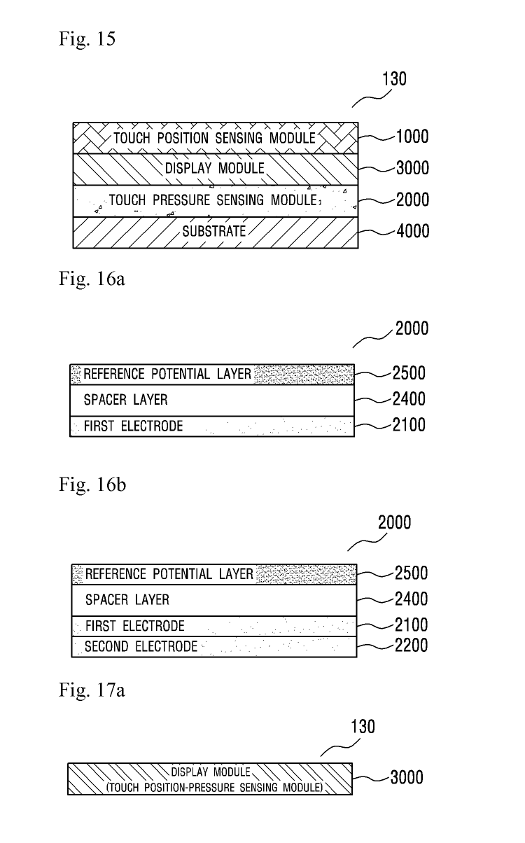

As shown in FIG. 15, a touch input device 130 according to a third embodiment may include the touch position sensing module 1000, the display module 3000 disposed under the touch position sensing module 1000, the touch pressure sensing module 2000 disposed under the display module 3000, and the substrate 4000 disposed under the touch pressure sensing module 2000.

In the touch input devices 130 according to the embodiment shown in FIGS. 10 and 13, since the touch pressure sensing module 2000 which includes the spacer layer 2400 or the touch position-pressure sensing module 5000 which includes the spacer layer 5400 is disposed on the display module 3000, the color clarity, visibility, optical transmittance of the display module 3000 may be reduced. Therefore, in order to prevent such problems, the touch position sensing module 1000 and the display module 3000 are fully laminated by using an adhesive like an optically clear adhesive (OCA), and the touch pressure sensing module 2000 is disposed under the display module 3000. As a result, the aforementioned problem can be alleviated and solved. Also, an existing gap formed between the display module 3000 and the substrate 4000 is used as the spacer layer for detecting the touch pressure, so that the overall thickness of the touch input device 130 can be reduced.

The touch position sensing module 1000 according to the embodiment shown in FIG. 15 is the same as the touch position sensing module shown in FIGS. 11a to 11d.

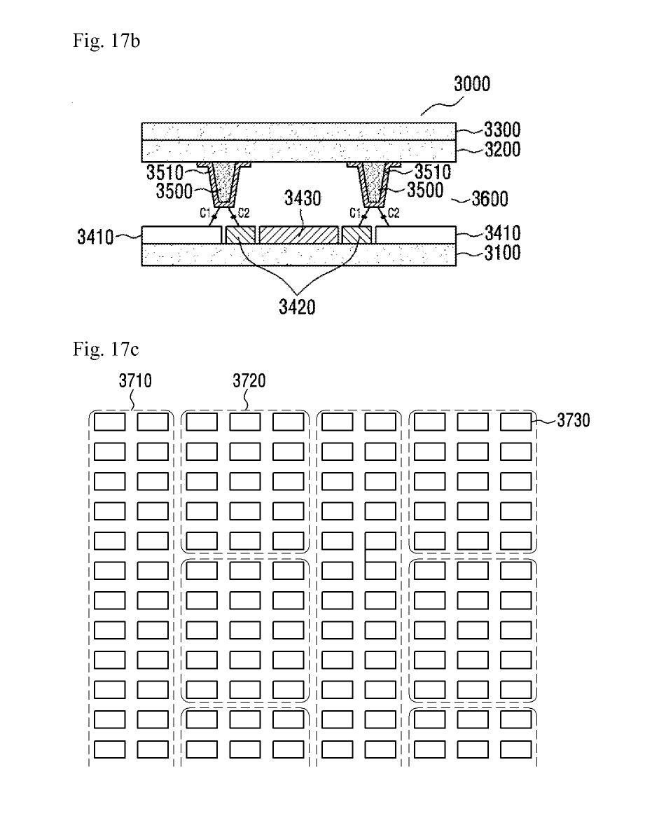

The touch pressure sensing module 2000 according to the embodiment shown in FIG. 15 may be the touch pressure sensing module shown in FIGS. 12a to 12f and the touch pressure sensing module shown in FIGS. 16a to 16b.

As shown in FIG. 16a, the touch pressure sensing module 2000 according to the embodiment may include the reference potential layer 2500, the spacer layer 2400 formed under the reference potential layer 2500, and the first electrode 2100 formed under the spacer layer 2400. Since the configuration and operation of FIG. 16a are the same as those of FIGS. 12a and 12b with the exception of the fact that the position of the reference potential layer 2500 and the position of the first electrode 2100 are replaced with each other, repetitive descriptions thereof will be omitted hereafter.

As shown in FIG. 16b, the touch pressure sensing module 2000 according to the embodiment may include the reference potential layer 2500, the spacer layer 2400 formed under the ground, the first electrode 2100 formed in a layer under the spacer layer 2400, and the second electrode 2200 formed in a layer under the layer in which the first electrode 2100 has been formed. Since the configuration and operation of FIG. 16b are the same as those of FIGS. 12c and 12d with the exception of the fact that the position of the reference potential layer 2500, the position of the first electrode 2100 and the position of the second electrode 2200 are replaced with each other, repetitive descriptions thereof will be omitted hereafter. Here, even when the first electrode 2100 and the second electrode 2200 are formed in the same layer, the touch pressure can be detected as described in FIGS. 12c and 12d.

Although it has been described in FIG. 15 that the display module 3000 is disposed under the touch position sensing module 1000, the touch position sensing module 1000 can be included within the display module 3000. Also, although it has been described in FIG. 15 that the touch pressure sensing module 2000 is disposed under the display module 3000, a portion of the touch pressure sensing module 2000 can be included within the display module 3000. Specifically, the reference potential layer 2500 of the touch pressure sensing module 2000 may be disposed within the display module 3000, and the electrodes 2100 and 2200 may be formed under the display module 3000. As such, when the reference potential layer 2500 is disposed within the display module 3000, a gap formed within the display module 3000 is used as the spacer layer for detecting the touch pressure, so that the overall thickness of the touch input device 130 can be reduced. Here, the electrodes 2100 and 2200 may be formed on the substrate 4000. As such, when the electrodes 2100 and 2200 are formed on the substrate 4000, not only the gap formed within the display module 3000 but also the gap formed between the display module 3000 and the substrate 4000 is used as the spacer layer for detecting the touch pressure, so that the sensitivity for detecting the touch pressure can be more improved.

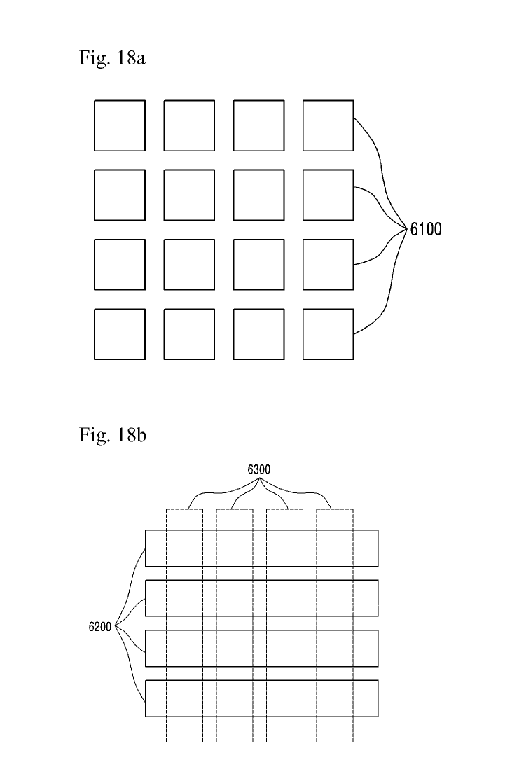

FIG. 17a shows a structure of the touch input device according to a fourth embodiment. As shown in FIG. 17a, the touch input device 130 according to the fourth embodiment may include at least one of the touch position sensing module and the touch pressure sensing module within the display module 3000.

FIGS. 17b and 17c are structure views of touch pressure sensing and touch position sensing of the touch input device according to the fourth embodiment. FIGS. 17b and 17c take an LCD panel as an example of the display module 3000.

In case of the LCD panel, the display module 3000 may include a TFT layer 3100 and a color filter layer 3300. The TFT layer 3100 includes a TFT substrate layer 3110 disposed directly thereon. The color filter layer 3300 includes a color filter substrate layer 3200 disposed directly thereunder. The display module 3000 includes a liquid crystal layer 3600 between the TFT layer 3100 and the color filter layer 3300. Here, the TFT substrate layer 3110 includes electrical components necessary to generate an electric field driving the liquid crystal layer 3600. Particularly, the TFT substrate layer 3110 may be comprised of various layers including a data line, a gate line, TFT, a common electrode, a pixel electrode and the like. These electrical components generate a controlled electric field and orient the liquid crystals in the liquid crystal layer 3600.

As shown in FIG. 17b, the display module 3000 according to the embodiment of the present invention may include sub-photo spacers 3500 disposed on the color filter substrate layer 3200. These sub-photo spacers 3500 may be disposed on the interface between the low common electrode 3410 and the adjacent guard shield electrode 3420. Here, a conductive material layer 3510 like ITO may be patterned on the sub-photo spacer 3500. Here, a fringing capacitance C1 is formed between the low common electrode 3410 and the conductive material layer 3510, and a fringing capacitance C2 is formed between the guard shield electrode 3420 and the conductive material layer 3510.

When the display module 3000 shown in FIG. 17b functions as the touch pressure sensing module, a distance between the sub-photo spacers 3500 and the TFT substrate layer 3110 may be reduced by an external pressure, and thus, a capacitance between the low common electrode 3410 and the guard shield electrode 3420 may be reduced. Accordingly, in FIG. 17b, the conductive material layer 3510 functions as the reference potential layer and detects the change of the capacitance between the low common electrode 3410 and the guard shield electrode 3420, so that the touch pressure can be detected.

FIG. 17c shows a structure in which the LCD panel as the display module 3000 is used as the touch position sensing module. The arrangement of the common electrodes 3730 is shown in FIG. 17c. Here, for the purpose of detecting the touch position, these common electrodes 3730 may be divided into a first area 3710 and a second area 3720. Accordingly, for example, the common electrodes 3730 included in one first area 3710 may be operated in such a manner as to function in response to the first electrode 6400 of FIG. 18c, and the common electrodes 3730 included in one second area 3720 may be operated in such a manner as to function in response to the second electrode 6500 of FIG. 18c. That is, in order that the common electrodes 3730, i.e., electrical components for driving the LCD panel are used to detect the touch position, the common electrodes 3730 may be grouped. Such a grouping can be accomplished by a structural configuration and manipulation of operation.

As described above, in FIG. 17, the electrical components of the display module 3000 are caused to operate in conformity with their original purpose, so that the display module 3000 performs its own function. Also, at least some of the electrical components of the display module 3000 are caused to operate for detecting the touch pressure, so that the display module 3000 functions as the touch pressure sensing module. Also, at least some of the electrical components of the display module 3000 are caused to operate for detecting the touch position, so that the display module 3000 functions as the touch position sensing module. Here, each operation mode may be performed in a time-division manner. In other words, the display module 3000 may function as the display module in a first time interval, as the pressure sensing module in a second time interval, and/or as the position sensing module in a third time interval.

FIGS. 17b and 17c only show the structures for the detection of the touch pressure and the touch position respectively for convenience of description. So long as the display module 3000 can be used to detect the touch pressure and/or the touch position by operating the electrical components for the display operation of the display module 3000, the display module 3000 can be included in the fourth embodiment.

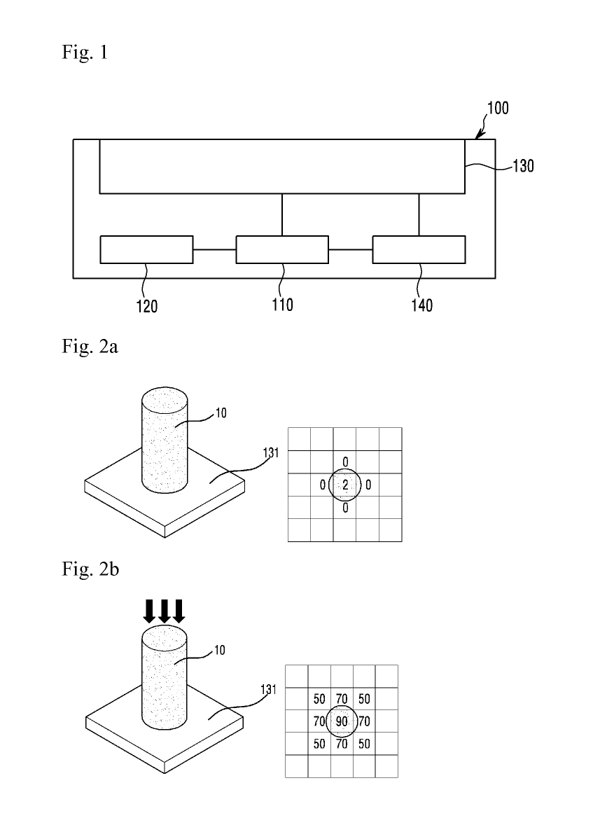

FIG. 1 is a structure view of the menu control device 100 according to the embodiment of the present invention.

The menu control device 100 according to the embodiment may include a controller 110, the touch input device 130, and a processor 140.

The menu control device 100 includes the touch input device 130. Input to the menu control device 100 may be performed by touching the touch input device 130.

The menu control device 100 may be a portable electronic device like a laptop computer, a personal digital assistant (PDA) and a smartphone.

When the touch occurs on the touch input device 130, the processor 140 can calculate whether the touch occurs on the touch input device 130 or not and the position of the touch. Also, the processor 140 can measure the amount of the capacitance change occurring according to the touch when the touch occurs on the touch input device 130.

Specifically, through the touch position sensing module 1000 or the touch position-pressure sensing module 5000 of the touch input device 130, the processor 140 can measure capacitance change amount according to the approach of an object 10 to the touch input device 130 and can calculate the touch position from the measured capacitance change amount.

Also, the capacitance change amount may be changed according to the touch pressure and/or touch area when the touch occurs. Therefore, when the touch occurs on the touch input device 130, the processor 140 can measure the capacitance change amount according to the touch pressure and/or the touch area. Here, the less the touch pressure and/or the touch area becomes, the less the capacitance change amount becomes, and the greater the touch pressure and/or the touch area becomes, the greater the capacitance change amount becomes.

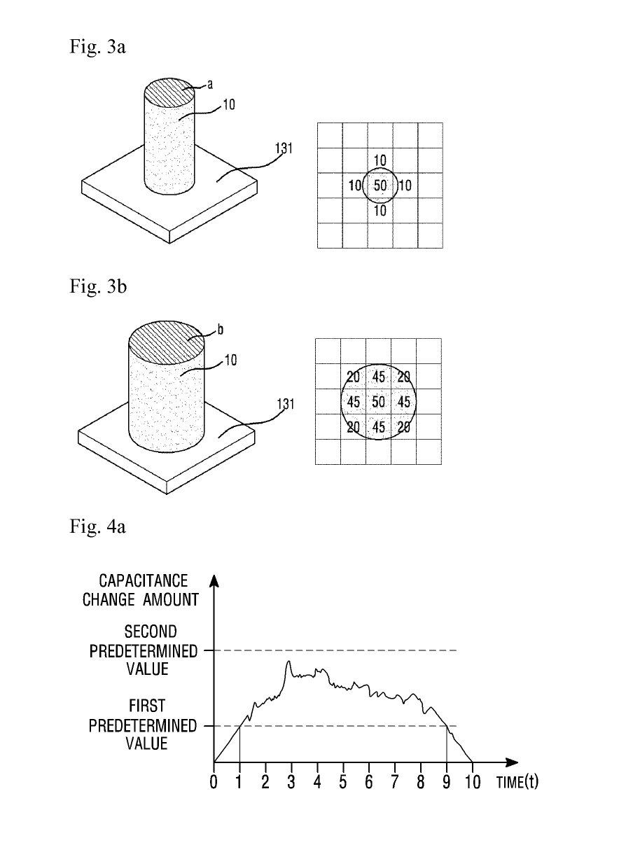

Specifically, the processor 140 may measure the capacitance change amount caused by the pressure which is applied from the object 10 to the touch input device 130 through the touch pressure sensing module 2000 or the touch position-pressure sensing module 5000 of the touch input device 130 and may calculate the touch pressure from the measured capacitance change amount. The capacitance change amount which is generated by the object 10 touching the touch input device 130 can be measured by summing the capacitance change amounts of each of a plurality of sensing cells. For example, as shown in FIG. 2a, when a common touch is input to the touch input device 130 by the object 10, the sum of the capacitance change amounts is 2. Also, as shown in FIG. 2b, when the touch with pressure is input to the touch input device 130 by the object 10, the sum of the capacitance change amounts is 570 (=90+70+70+70+70+50+50+50+50).

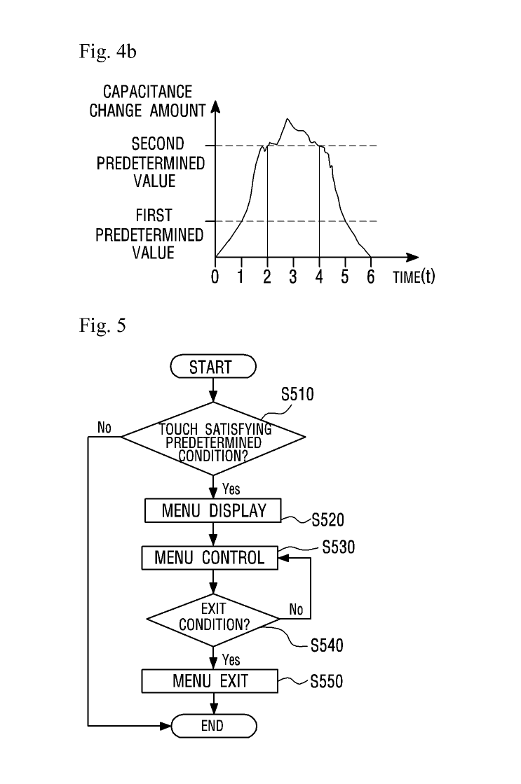

Also, specifically, the processor 140 may measure the capacitance change amount caused by the approach of the object 10 to the touch input device 130 through the touch position sensing module 1000 or the touch position-pressure sensing module 5000 of the touch input device 130 and may calculate the touch area from the measured capacitance change amount. For example, as shown in FIG. 3a, when the area of the object 10 touching the touch input device 130 is “a”, the capacitance change amount is 90 (=50+10+10+10+10). Also, as shown in FIG. 3b, when the area of the object 10 touching the touch input device 100 is “b”, the capacitance change amount is 310 (=50+45+45+45+45+20+20+20+20). Here, the magnitude of the pressure which is applied when the object 10 touches the touch input device 100 in both FIGS. 3a and 3b may be 0 or the same.

In particular, although the processor 140 according to the embodiment of the present invention does not touch directly the touch input device 130, the processor 140 is able to recognize a hovering state in which the object like the finger is close enough to the touch input device 130 to cause the change of the capacitance in the touch input device 130.

For example, when the object is located within about 2 cm from the surface of the touch input device 130, the processor 140 measures the capacitance change amount according to the approach of the object 10 to the touch input device 130 through the touch position sensing module 1000 or the touch position-pressure sensing module 5000 of the touch input device 130, and then is able to calculate, from the measured capacitance change amount, whether or not the object exists and the where the object is located.

In order that the movement of the object is recognized as hovering over the touch input device 130, it is desirable that the error of the capacitance change amount which is generated in the touch input device 130 by the hovering is larger than that of the capacitance change which is generated in the common touch input device 130.

The capacitance change amount in the touch input device 130, which is generated during the hovering of the object, may be smaller than the capacitance change amount of the direct touch on the touch input device 130. Hereafter, the touch on the touch input device 130 may include the hovering. For example, the hovering may be classified as having the smallest touch pressure and/or the smallest touch area.

Therefore, the processor 140 may detect the capacitance change amount generated in the touch input device 130, may calculate whether the touch occurs or not, the touch position and touch pressure magnitude or touch area, or may measure the capacitance change amount caused by the touch.

The measured capacitance change amount and at least any one of the touch position, touch pressure magnitude and touch area calculated from the measured capacitance change amount are transmitted to the controller 110 by the processor 140. Here, the controller 110 may calculate a touch time period by using the capacitance change amount transmitted from the processor 140.

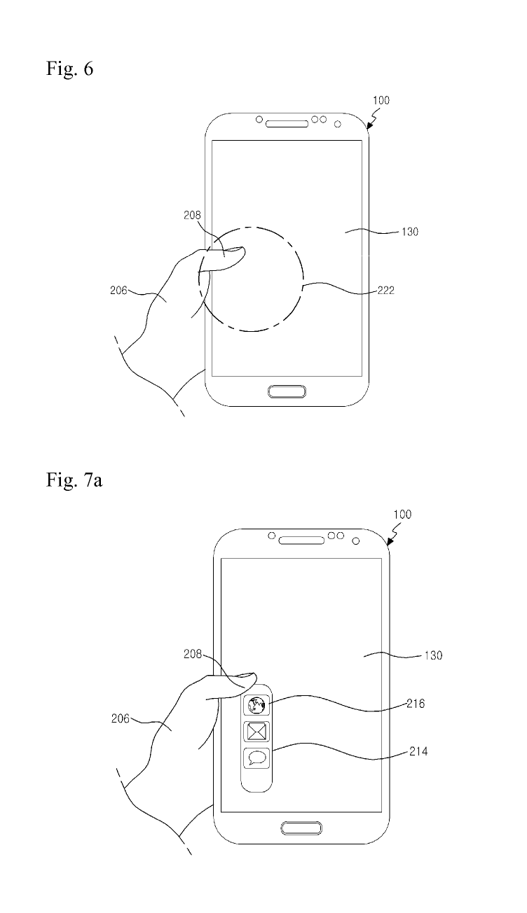

Specifically, when the touch on the touch input device 130 corresponds to the hovering, the controller 110 measures a time period during which the capacitance change amount is maintained from a first predetermined value to a second predetermined value, and thus, calculates a time period during which the object touches the touch input device 130. Here, the first predetermined value may be the minimum value of the capacitance change amount which causes the touch to be recognized as the hovering, and the second predetermined value may be the maximum value of the capacitance change amount which causes the touch to be recognized as the hovering. For example, when the first predetermined value is 20 and the second predetermined value is 50, a time period during which the capacitance change amount is maintained from 20 to 50 is, as shown in FIG. 4a, 8t, so that the touch time period of the hovering is 8t.

Also, when the touch occurs directly on the touch input device 130, the controller 110 measures a time period during which the capacitance change amount is maintained greater than the second predetermined value, and thus, calculates a time period during which the object touches the touch input device 130. For example, when the second predetermined value is 50, a time period during which the capacitance change amount is maintained greater than 50 is, as shown in FIG. 4b, 2t, so that the touch time period of the direct touch is 2t.

The controller 110 determines whether the touch on the touch input device 130 is a menu entry input or not based on at least one of the capacitance change amount, touch position, the touch pressure magnitude, touch area which have been transmitted from the processor 140. When there is the menu entry input, the controller 110 displays the menu and controls the overall operation for menu control. Specifically, depending on the change of at least one of the touch pressure magnitude, touch area, touch time period which have been calculated based on at least any one of the capacitance change amount, touch position, touch pressure magnitude and touch area which have been transmitted from the processor 140, and have been input to an icon displayed on the menu, the controller 110 may display other icons, which are different from the displayed icon, on the menu. Here, the touch input to the icon may include not only a direct touch on the icon but also a touch on any position for the selection of the icon. The touch input to the icon does not necessarily need to be positioned on the icon.

Also, depending on at least one of the touch pressure magnitude, touch area, touch time period which have been calculated based on at least any one of the capacitance change amount, touch position, touch pressure magnitude and touch area which have been transmitted from the processor 140, and have been input to the displayed icon, the controller 110 determines whether the touch input to the icon displayed on the menu is released or not. When it is determined that the touch input to the icon displayed on the menu is released, the controller 110 may perform an action assigned to the icon.

Also, the controller 110 determines whether the touch input to the touch input device 130 satisfies a menu exit condition or not based on at least one of the capacitance change amount, touch position, touch pressure magnitude, touch area which have been transmitted from the processor 140. When it is determined that the touch input to the touch input device 130 satisfies a menu exit condition, the controller 110 may exit the menu.

The controller 110 according to the embodiment may be an application processor. The application processor is able to perform the command interpretation, operation, and control, etc., in the portable electronic device.

The menu control device 100 according to the embodiment of the present invention may further include a memory 120.

The memory 120 may store a program for the operation of the controller 110 or may temporarily store data to be input/output. For example, the memory according to the embodiment of the present invention may store the condition of the touch on the touch input device 130 for entering the menu. Also, the memory 120 may store the icon to be displayed on the menu. Also, the memory 120 may store the condition of the touch to perform the action assigned to the icon to be displayed on the menu. Also, the memory 120 may store the condition of the touch on the touch input device 130 for exiting the menu. The memory 120 may include at least one type of a storage medium selected from the group consisting of a flash memory type, a hard disk type, a multimedia card micro type, a card type memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

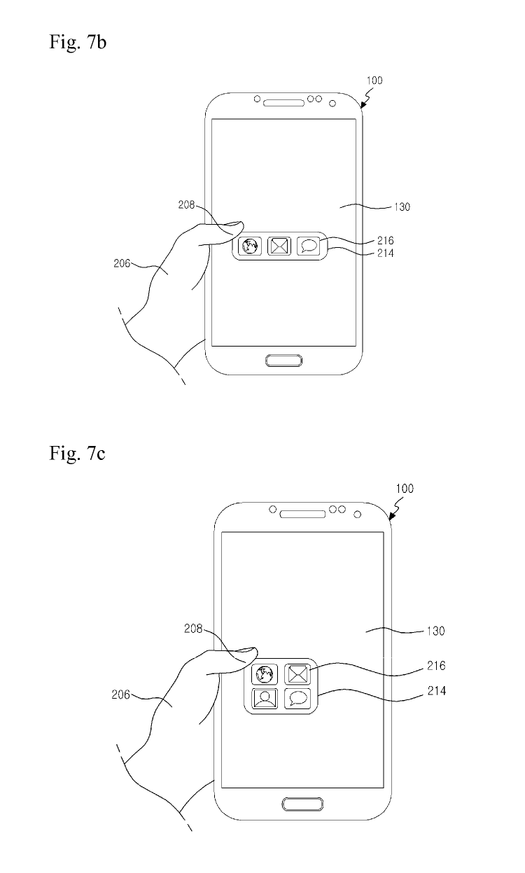

FIG. 5 is a flowchart for describing a menu control method according to the embodiment of the present invention.

Referring to FIG. 5, the menu control method according to the embodiment of the present invention may include determining whether or not a signal input to the touch input device is a touch satisfying a predetermined condition (S510), displaying the menu when it is determined that the signal is the touch satisfying the predetermined condition (S520), controlling the menu (S530), determining whether the menu exit condition is satisfied or not (S540), and exiting the menu (S550).

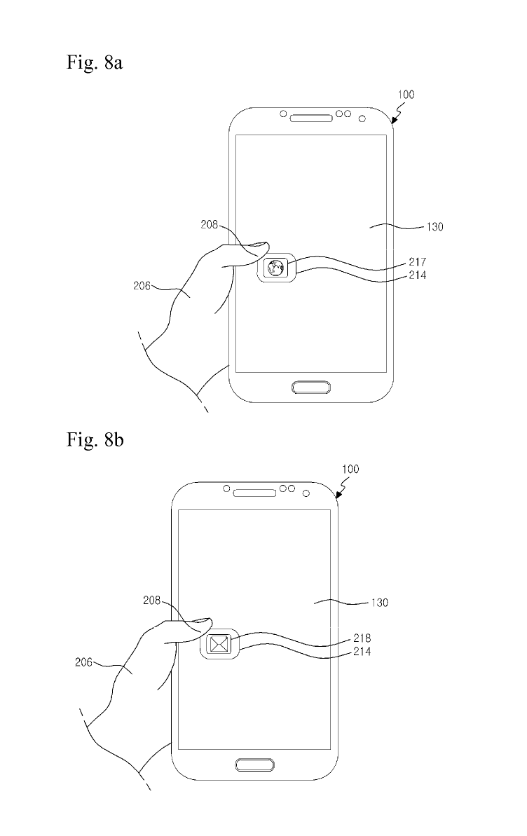

FIG. 6 shows an example of the menu entry method according to the embodiment of the present invention.

Hereafter, the determining whether or not a signal input to the touch input device is a touch satisfying a predetermined condition (S510) will be described in detail with reference to FIG. 6.

Due to the enlargement of the menu control device 100, the user has a difficulty in operating the touch input device 130 while holding the menu control device 100 by one hand. That is, since the icon to be used may be positioned out of reach 222 of thumb 208 of the user or may exist on another page, the user is not able to perform the actions assigned to all of the icons only by the thumb 208 of the user holding the menu control device 100.

Here, the user may select the icon to be used by using the other hand. However, depending on situations, it may be difficult or impossible for the user to select the icon by using the other hand. This should be improved for the sake of convenience.

Also, when the user is able to perform a specific menu only through a multi-step input during playing a game which is performed in the menu control device 100, particularly, a game which is performed in real time, the user is not allowed to operate characters in the game during a time required for the multi-step input to perform the specific menu, so that the user may feel inconvenient in playing the game. For example, in a real time combat game, when the user tries to change the weapon of the character in the game, the character is exposed to the attack from the opponent character during a period of time for changing the weapon.

Therefore, the embodiment of the present invention provides a menu control technology for overcoming the inconveniences and problems. Here, the menu may include at least one icon. The icon is a small picture, symbol or text which is displayed on the touch input device 130 and may represent an application which is performed in the menu control device 100, file or folder. When the icon is performed by touching, etc., an application corresponding to the icon is performed in the menu control device 100, or the action assigned to the icon, for example, opening the file or folder, or the like, may be performed. Also, the icon may be an icon in the game, which is performed in the menu control device 100. When the corresponding icon is performed by touching, etc., the action assigned to the corresponding icon may be performed during playing the game. The touch input device 130 according to the embodiment of the present invention makes it possible for the user to operate the computing system by simply touching a screen by his/her finger, etc.

When the touch on the touch input device 130 satisfies the predetermined condition, it is possible to enter the menu.

The predetermined condition may be that the touch occurs in one position of the touch input device 130 during a time period longer than a predetermined period of time. Specifically, the predetermined condition may be that after the first touch is input to the touch input device 130, the touch is maintained continuously for the predetermined period of time and the position variation of the touch is within a predetermined range.

The touch which is input for entering the menu includes the hovering as well as the direct touch on the touch input device 130.

Also, the predetermined condition may be that the object touches the touch input device 130 with a pressure magnitude greater than a predetermined pressure magnitude and/or with an area greater than a predetermined area. For example, the predetermined condition may be that the touch input device 130 is touched, as shown in FIG. 2b, with the sum of the capacitance change amounts larger than 570 due to the pressure. Also, the predetermined condition may be that the touch input device 130 is touched, as shown in FIG. 3b, with the sum of the capacitance change amounts larger than 310 due to the area. Also, a combination of both may be set as the predetermined condition.

Also, the predetermined condition may be that the object touches the touch input device 130 in a particular pattern. For example, the predetermined condition may be that the finger 208 touches the touch input device 130 in a heart-shaped pattern.

Also, the predetermined condition may be that the finger 208 drags on a particular position of the touch input device 130. For example, the predetermined condition may be that the finger 208 touches the outer portion of the touch input device 130, and then drags to the inner portion of the touch input device 130.

Also, the predetermined condition may be that the object touches the touch input device 130 to a specific rhythm. For example, the predetermined condition may be that the finger 208 touches continuously the touch input device 130 twice.

Here, the predetermined conditions may be combined with each other. For example, the predetermined condition may be that the finger 208 touches continuously the touch input device 130 twice and the second touch occurs at a pressure greater than a predetermined pressure or with an area greater than a predetermined area. Here, the first touch may occur at a pressure less than a predetermined pressure or with an area less than a predetermined area.

Accordingly, the condition that the object touches one position of the touch input device 130 during a time period longer than a predetermined period of time, the condition that the object touches with a pressure magnitude greater than a predetermined pressure magnitude, the condition that the object touches with an area greater than a predetermined area, the condition that the object touches in a particular pattern, the condition that the object drags from a particular position, and the condition that the object touches to a specific rhythm may be combined with each other.

The predetermined conditions may be stored in the memory 120. The controller 110 makes reference to the memory 120, and then determines whether the input to the touch input device 130 meets the predetermined condition or not.

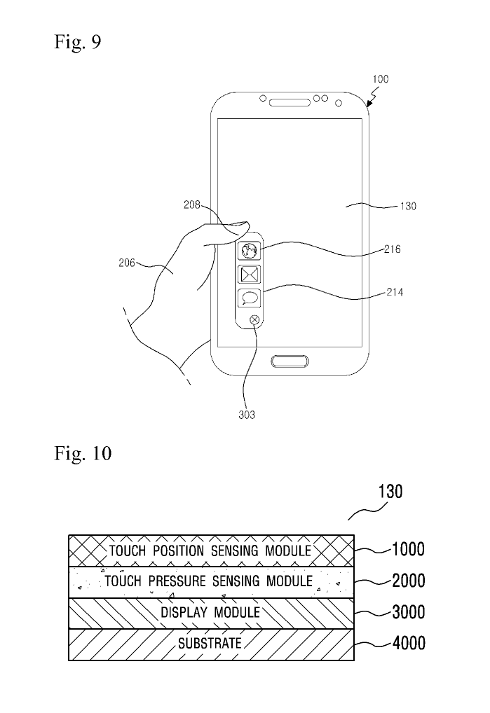

FIGS. 7a to 7c show various menus according to a first embodiment.

Hereafter, the menu according to the first embodiment, the displaying the menu when it is determined that the touch satisfies the predetermined condition (S520), and the controlling the menu (S530) will be described in detail with reference to FIG. 7.

When the touch input device 130 satisfies the predetermined condition, a menu 214 may be displayed on some portions of the touch input device 130.

The menu 214 may display one or more icons 216. Specifically, as shown in FIG. 7a, the menu 214 may display the icons 216 in a plurality of rows. Also, as shown in FIG. 7b, the menu 214 may display the icons 216 in a plurality of columns. Also, as shown in FIG. 7c, the menu 214 may display the icons 216 in a plurality of rows and columns. Here, the icon 216 may be user's favorite icon and be registered in advance.

Although the menu 214 is shown in the form of a quadrangular box border including the icon 216 in FIGS. 7a to 7c, this is only an example. The menu 214 does not necessarily need to be visually and prominently displayed. For instance, the menu 214 may be treated as transparent and only the icon 216 may be displayed to be visually identified. Through such a configuration, an area blocked by the menu 214 can be minimized.

The action assigned to the icon 216 is performed by touching the icon 216 displayed on the menu 214.

Also, the touch input to the icon 216 is released by separating the touch input device 130 from the object which has touched the icon 216, so that the action assigned to the icon 216 can be performed. Specifically, the user selects a desired icon 216 by touching the menu 214 with the finger 208, and then may perform the action assigned to the icon 210 by releasing the input touch. Here, when the selected icon 216 is not the desired icon, the user selects the desired icon by sliding the finger 208 which has touched the menu 214, and then may perform the action assigned to the desired icon by releasing the input touch. As such, when the action assigned to the icon 216 is performed by releasing the touch input to the icon 216, there is no requirement for a separate touch for performing the action assigned to the icon 216. Therefore, it is possible to more easily perform the action assigned to the icon 216.

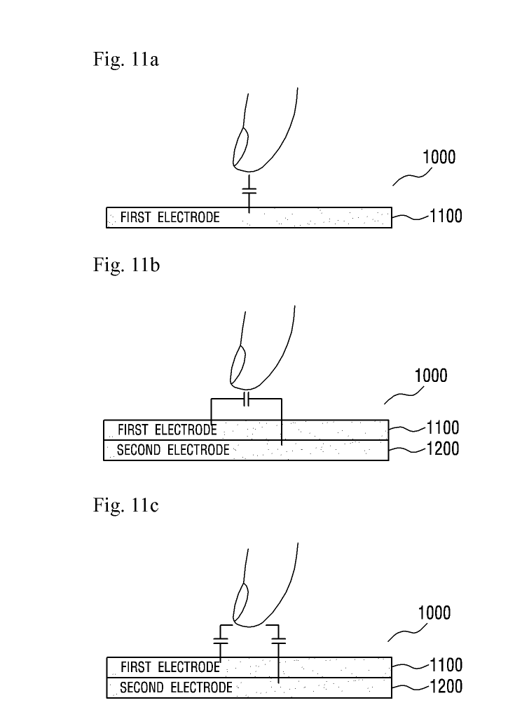

According to the embodiment, through one touch, the menu 214 may be displayed and the icon may be selected and performed. For example, the menu 214 may be displayed by the touch which satisfies a predetermined condition. Here, without releasing the touch and without changing the touch position to the position of the desired icon 216, the user is able to select the icon 216 by controlling the pressure level and/or area level of the corresponding touch at the touch position for displaying the menu 214. According to the embodiment, when the touch pressure level, touch area level and/or touch time period level are assigned to each of the icons 216, it may be displayed that the icon has been selected by means of a distinction method, for example, shade/bold/brightness/color/blinking, etc. Also, according to the embodiment, in preparation for a case where the finger hides the icon 216 in the menu 214 so that it is impossible to recognize which icon 216 has been selected, the selected icon 216 may be displayed on the top part of the display screen (preferably, a part which is not hidden by the finger). The user is able to maintain the touch by controlling the touch pressure/touch area/touch time period until the desired icon 216 is selected. Then, when the desired icon 216 is selected, the user releases the touch at the position of the corresponding touch, so that the corresponding icon 216 can be performed. Also, according to the embodiment, when the desired icon 216 is selected, the user slides the corresponding touch and places the finger on the position of the icon 216 in the menu 214. Then, the user releases the touch and performs the icon 216. Also, according to the embodiment, when the icon 216 is selected, the user slides the touch to the icon 216 displayed at a position other than the menu 214 (for example, displayed on the top part which is not hidden by the finger) in order to confirm the selection of the icon and places the finger on the icon 216 at the position other than the menu 214, and then performs the icon 216 by releasing the touch. The description of this paragraph can be applied in the same manner to the second embodiment of FIG. 8 with the exception of the fact that the one icon is displayed on the menu 214 and replaced with another icon. Here, since only the one icon 216 is displayed on the menu 214, it is apparent to those skilled in the art that there is no need to indicate by a particular method that the icon 216 has been selected by shade/bold/brightness/color/blinking, etc.

FIGS. 8a to 8b show a menu according to a second embodiment.

Hereafter, the menu according to the second embodiment, the displaying the menu when it is determined that the touch satisfies the predetermined condition (S520), and the controlling the menu (S530) will be described in detail with reference to FIG. 8.

Also, hereafter, the same part as that of the first embodiment will be omitted to avoid the repetitive descriptions. Therefore, the difference from the first embodiment will be focused.

The displaying S520 the menu according to the second embodiment may include a first step of displaying at least one of the icons registered in advance, and a second step of displaying at least one icon different from the displayed icon, depending on the change of at least one of the pressure magnitude of the input touch, the touch area and touch time period.

Specifically, as shown in FIG. 8a, a first icon 217 may be displayed on the menu 214 (the first step), and as shown in FIG. 8b, a second icon 218 may be displayed (the second step). Specifically, the first icon 217 may be displayed on the menu 214 (the first step), and subsequently, the first icon 217 may be deleted, and then the second icon 218 may be displayed (the second step).

More specifically, the icon to be displayed on the menu 214 may be changed by the capacitance change amount according to the touch pressure magnitude and/or touch area.

For example, when it is assumed that the sum of the capacitance change amounts has a value of from 0 to 400, a touch level may be determined as a first level for the sum of the capacitance change amounts in a range with the smallest value from greater 0 to 100, may be determined as a second level for the sum of the capacitance change amounts in a range with the next largest value from greater 100 to 200, may be determined as a third level for the sum of the capacitance change amounts in a range with the next largest value from greater 200 to 300, and may be determined as a fourth level for the sum of the capacitance change amounts in a range with the largest value from greater 300 to 400.

Therefore, when the touch level is the first level, the first icon 217 may be, as shown in FIG. 8a, displayed on the menu 214, and when the touch level is calculated as the second level, the second icon 218 may be, as shown in FIG. 8b, displayed on the menu 214, and when the touch level is calculated as the third and fourth levels, a third icon and a fourth icon (not shown) may be displayed respectively.

Here, when the icon desired by user favorite icon is not displayed, it is possible to cause the desired icon to be displayed by controlling the touch pressure magnitude and/or touch area.

For example, in the first step in which the first icon 217 has been, as shown in FIG. 8a, displayed on the menu 214, when the action assigned to the second icon 218 is intended to be performed, the first step may be changed into the second step in which the second icon 218 is, as shown in FIG. 8b, displayed on the menu 214 by controlling the touch pressure magnitude and/or touch area.

When the icon desired by the user is displayed, the action assigned to the icon 217 and 218 may be performed by touching the icon 217 and 218 displayed on the menu 214. Also, the action assigned to the icon 217 and 218 may be performed by releasing the touch input to the icon 217 and 218. As such, when the action assigned to the icon 216 is performed by releasing the touch input to the icon 216, there is no need for a separate touch for performing the action assigned to the icon 216, so that the action assigned to the icon 216 can be more conveniently performed.

Here, for example, when the input touch is released so as to perform the action assigned to the fourth icon corresponding to the fourth level, the touch level is changed from the fourth level into the third to the first level while the touch is released. Here, it is set such that the touch level is not selected when a staying time at each level is less than a predetermined time, so that it is possible to prevent that an incorrect touch level is selected in releasing the touch. Accordingly, it is possible to prevent that an incorrect selection is made when the touch pressure magnitude and/or touch area are rapidly changed, for example, the release of the touch. Therefore, when the fourth level is selected and the touch is released, it is possible to prevent an error in which the first level, i.e., the last level is selected as touch level.

Here, while FIGS. 8a and 8b show that one icon is displayed for each level in the menu 214, the present invention is not necessarily limited to this, and two or more icons may be displayed for a certain level in the menu 214. Accordingly, in the first level, two icons may be displayed on the menu 214. In the second level, another two icons different from the two icons may be displayed on the menu 214.

In the state where two or more icons have been displayed on the menu 214, when it is intended that the action assigned to the icon is performed by releasing the touch input to the menu 214, the desired icon is selected by sliding the finger 208 which has touched the menu 214, and then the action assigned to the icon can be performed by releasing the input touch.

Meanwhile, in the state where only one icon has been displayed on the menu 214, when it is intended that the action assigned to the icon is performed by releasing the touch input to the menu 214, the action assigned to the icon can be performed by releasing the input touch without separately selecting the icon, because the icon already displayed on the menu 214 is the icon that the user desires.

For instance, when the user wants to perform the action assigned to the second icon 218, the menu 214 is displayed by the touch satisfying a predetermined condition, the second icon 218 is displayed on the menu 214 by controlling the touch pressure magnitude and/or touch area, and then the touch is released. As a result, the action assigned to the second icon 218 displayed on the menu 214 can be immediately performed.

Also, the icon to be displayed on the menu 214 may be changed depending on the touch time period. Specifically, when it is assumed that the touch time period has a value of from 0t to 12t, the touch level in a range with a value from greater 0t to 3t may be calculated as a first level, the touch level in a range with the next largest value from greater 3t to 6t may be calculated as a second level, the touch level in a range with the next largest value from greater 6t to 9t may be calculated as a third level, and the touch level in a range with the largest value from greater 9t to 12t may be calculated as a fourth level.

Therefore, when the touch level is the first level, the first icon 217 may be, as shown in FIG. 8a, displayed on the menu 214, and when the touch level is calculated as the second level, the second icon 218 may be, as shown in FIG. 8b, displayed on the menu 214, and when the touch level is calculated as the third and fourth levels, a third icon and a fourth icon (not shown) may be displayed respectively.

Here, when the icon desired by user favorite icon is not displayed, it is possible to cause the desired icon to be displayed by controlling the touch time period.

For example, in the first step in which the first icon 217 has been, as shown in FIG. 8a, displayed on the menu 214, when the action assigned to the second icon 218 is intended to be performed, the first step may be changed into the second step in which the second icon 218 is, as shown in FIG. 8b, displayed on the menu 214 by controlling the touch time period.

When the desired icon does not appear, the user is able to select the desired icon by maintaining the touch until the desired icon is displayed. However, after the desired icon went past, the desired icon cannot be selected by turning the icon back.

In this case, the user maintains the touch for a time period longer than a predetermined maximum touch time period, and thus, is able to select the previously displayed icon. As a result, the desired icon can be selected.

Specifically, when the touch time period exceeds the maximum of the fourth level, the touch level starts again from the first level. Here, the first icon 217 can be displayed again. Subsequently, as the touch time period increases, the icon may be displayed in the order of the second level, the third level and the fourth level.

Also, unlike the above-description, when the touch time period exceeds the maximum of the fourth level, the touch level is changed into the third level. Here, the third icon (not shown) may be displayed again. Subsequently, as the touch time period increases, the touch level is changed in reverse order, i.e., in the order of the second level and the first level. Then, when the touch level reaches the first level, the icon may be displayed such that the touch level is changed in the order of the second level and the third level.

Subsequently, a method for performing the action assigned to the selected icon is the same as that of the case where the icon is displayed according to the touch pressure magnitude and/or touch area.

Here, when the icon which is displayed on the menu 214 is changed according to the touch time period, a predetermined time is required to display the icon that the user desires on the menu 214. Contrarily, when the icon which is displayed on the menu 214 is changed according to the time pressure magnitude or touch area, the touch pressure magnitude or touch area input to the menu 214 is controlled so as to display the icon that the user desires on the menu 214. Accordingly, less time is required.

Here, when the icon which is displayed on the menu 214 is changed according to the touch area, it is possible to implement the menu display operation according to the embodiment of the present invention even without hardware which detects the touch pressure. Meanwhile, when the icon which is displayed on the menu 214 is changed according to the time pressure magnitude, there is an advantage of linearly controlling the magnitude of the touch pressure. Also, in order to display the icon that the user desires on the menu 214, the pressure magnitude of the touch input to the menu 214 can be easily controlled. Furthermore, even when an object like a conductive rod is used, the magnitude of the touch pressure can be easily controlled.

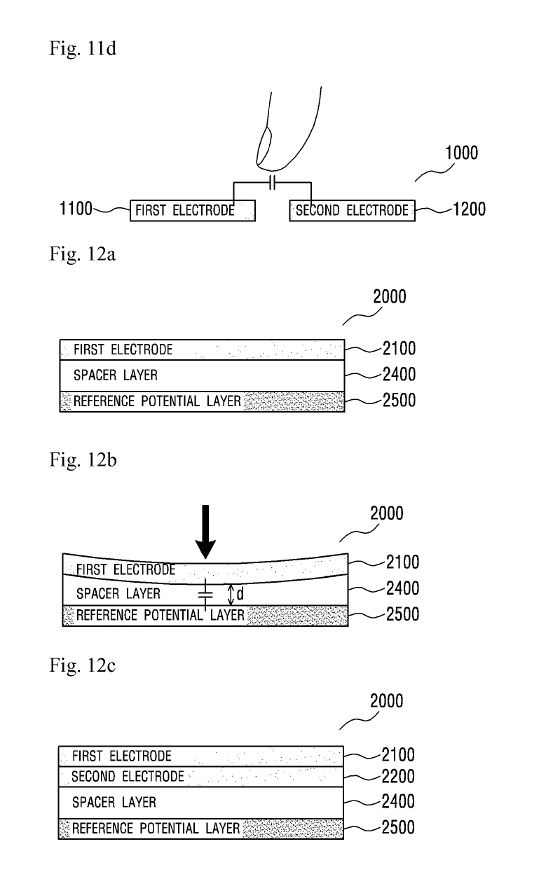

FIG. 9 shows a menu exit method in accordance with the embodiment.

Hereafter, the determining whether the menu exit condition is satisfied or not (S540), and the exiting the menu (S550) will be described in detail with reference to FIG. 9.

As shown in FIG. 9, the menu 214 can be exited by touching an exit mark 303 positioned on the menu 214 or outside the menu 214.

Also, the menu 214 can be exited by sliding the object which has touched the menu 214 to the exit mark 303 and then by releasing the input touch.

This is just an example. The menu 214 can be exited by performing the icon. Also, the menu 214 may be exited by touching an area outside the area where the menu 214 is displayed or may be exited by positioning the object which has touched the menu 214 to the area outside the area where the menu 214 is displayed and then by releasing the input touch. Also, the menu 214 may be exited even when there is no touch input for a time period longer than a predetermined period of time (e.g., 10 seconds) after entering the menu 214. Also, according to the embodiment, even when the touch is released without the touch of the icon 216, the menu 214 may be exited. For example, even when the touch is released without the touch of the icon 216 by the sliding of the finger to the icon 216 after the icon 216 is selected through the control of the touch pressure magnitude and/or touch area, the menu 214 may be exited. This can be accomplished by at least one selected from among the aforementioned methods, depending on the user's convenience.

As described above, in the menu control device 100 according to the embodiment, the operating the menu 214 allows the user to easily and rapidly perform the action assigned to the icon which is positioned on an area out of reach of the finger 208 of the user or positioned on another page.

Although preferred embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A menu control method comprising:
determining whether or not a touch input to a touch input device by an object satisfies at least any one of a condition that the object touches the touch input device for a time period longer than a predetermined time period, a condition that the object touches with a pressure magnitude greater than a predetermined pressure magnitude, a condition that the object touches with an area greater than a predetermined area, a condition that the object touches in a predetermined pattern, a condition that the object drags from a predetermined position, and a condition that the object touches to a predetermined rhythm;
displaying the menu on the touch input device when the touch input satisfies the predetermined condition; and
controlling operation of the touch input device according to manipulation to the menu by the object.

2. The menu control method of claim 1, wherein the displaying the menu comprises:
a first step of displaying a first icon on the menu; and
a second step of displaying a second icon on the menu, according to a change of at least one of the touch pressure magnitude, touch area and touch time period.

3. The menu control method of claim 2, wherein the second step comprises deleting the first icon.

4. The menu control method of claim 2, wherein, in at least one of the first and the second steps, only one icon is displayed.

5. The menu control method of claim 2, wherein, in the controlling operation of the touch input device, an action assigned to the icon is performed by releasing the touch.

6. The menu control method of claim 1,
wherein the displaying the menu comprises displaying at least one icon on the menu, and
wherein the controlling operation of the touch input device comprises:
selecting any one of at least one icon by controlling at least one of the pressure, area, and time period of the touch input;
placing the touch input on the icon selected among the at least one icon; and
performing an action assigned to the icon by releasing the touch placed on the selected icon.

7. The menu control method of claim 6, wherein the selecting any one of at least one icon by controlling at least one of the pressure, area, and time period of the touch input comprises displaying only the selected icon on the menu.

8. The menu control method of claim 6, wherein the selecting any one of at least one icon by controlling at least one of the pressure, area, and time period of the touch input; and the placing the position of the touch input on the icon selected among the at least one icon are performed without releasing the touch input.

9. The menu control method of claim 8, further comprising exiting the menu, wherein the exiting the menu is performed by releasing the touch input without placing the touch input on the selected icon.

10. The menu control method of claim 1, further comprising exiting the menu, wherein the exiting the menu is performed by touching an exit mark positioned on the touch input device or touching an area outside the area where the menu is displayed, or by releasing the touch input to the exit mark positioned on the touch input device or releasing the touch input to the area outside the area where the menu is displayed, or by inputting no touch on the touch input device for a time period longer than a predetermined period of time.

11. A menu control device comprising a touch input device, a processor and a controller,
wherein the processor measures a capacitance change amount according to a touch of an object on the touch input device and transmits at least one of the measured capacitance change amount and a touch position and a magnitude of a touch pressure calculated from the measured capacitance change amount to the controller, and
wherein, the controller:
based on at least one of the capacitance change amount, the touch position, the magnitude of the touch pressure which have been transmitted from the processor, determines whether or not the touch of the object on the touch input device satisfies at least any one of a condition that the object touches the touch input device for a time period longer than a predetermined time period, a condition that the object touches with a pressure magnitude greater than a predetermined pressure magnitude, a condition that the object touches with an area greater than a predetermined area, a condition that the object touches in a predetermined pattern, a condition that the object drags from a predetermined position, and a condition that the object touches to a predetermined rhythm;
displays the menu on the touch input device when the touch input satisfies the predetermined condition; and
controls operation of the touch input device according to manipulation to the menu by the object.

12. The menu control device of claim 11, wherein the displaying the menu comprises:
a first step of displaying a first icon on the menu; and
a second step of displaying a second icon on the menu, according to a change of at least one of the touch pressure magnitude, touch area and touch time period.

13. The menu control device of claim 12, wherein the second step comprises deleting the first icon.

14. The menu control device of claim 12, wherein, in at least one of the first and the second steps, only one icon is displayed.

15. The menu control device of claim 12, wherein, in the controlling operation of the touch input device, an action assigned to the icon is performed by releasing the touch.

16. The menu control device of claim 11,
wherein the displaying the menu comprises displaying at least one icon on the menu, and
wherein the controlling operation of the touch input device comprises:
selecting any one of at least one icon by controlling at least one of the pressure, area, and time period of the touch input;
placing the touch input on the icon selected among the at least one icon; and
performing an action assigned to the icon by releasing the touch placed on the selected icon.

17. The menu control device of claim 16, wherein the selecting any one of at least one icon by controlling at least one of the pressure, area, and time period of the touch input comprises displaying only the selected icon on the menu.

18. The menu control device of claim 16, wherein the selecting any one of at least one icon by controlling at least one of the pressure, area, and time period of the touch input; and the placing the position of the touch input on the icon selected among the at least one icon are performed without releasing the touch input.

19. The menu control device of claim 18, wherein the controller further performs exiting the menu, and wherein the exiting the menu is performed by releasing the touch input without placing the touch input on the selected icon.

20. The menu control device of claim 11, wherein the controller further performs exiting the menu, and wherein the exiting the menu is performed by touching an exit mark positioned on the touch input device or touching an area outside the area where the menu is displayed, or by releasing the touch input to the exit mark positioned on the touch input device or releasing the touch input to the area outside the area where the menu is displayed, or by inputting no touch on the touch input device for a time period longer than a predetermined period of time.
